(19) United States
(12) Patent Application Publication
(10) Pub. No.: US 2025/0365743 A1
(43) Pub. Date: Nov. 27, 2025

(54) SIDELINK MULTI-CHANNEL ACCESS BASED ON USER EQUIPMENT (UE) CAPABILITY

(71) Applicant: QUALCOMM Incorporated, San Diego, CA (US)

(72) Inventors: Giovanni Chisci, San Diego, CA (US); Chih-Hao Liu, San Diego, CA (US); Jing Sun, San Diego, CA (US); Xiaoxia Zhang, San Diego, CA (US); Yisheng Xue, San Diego, CA (US); Stelios Stefanatos, San Diego, CA (US); Qing Li, Princeton Junction, NJ (US); Jae Ho Ryu, San Diego, CA (US); Peter Gaal, San Diego, CA (US)

(21) Appl. No.: 18/873,108

(22) PCT Filed: Jul. 18, 2023
(86) PCT No.: PCT/US2023/070417

§ 371 Date: Dec. 9, 2024

(30) Foreign Application Priority Data
Aug. 11, 2022 (GR) 20220100683

(51) Int. Cl. H04W 72/25; H04W 74/0808

(52) U.S. Cl. CPC H04W 72/25; H04W 74/0808

(57) ABSTRACT

This disclosure provides systems, methods, and devices for wireless communication that support multi-channel access with respect to sidelink communication based on user equipment (UE) capability. In a first aspect, a UE providing sidelink transmission may implement sidelink unlicensed spectrum (SL-U) operation in which a multi-channel access procedure facilitates simultaneous access with respect to a plurality of different channel bandwidths in the unlicensed spectrum. Implementation of a particular SL-U multi-channel access procedure and/or UE capability independent from UE capability for multiple simultaneous transmissions. SL-U multi-channel access may facilitate transmission of a single sidelink channel over multiple channel bandwidths within a slot and/or transmission of multiple sidelink channels over multiple channel bandwidths within a slot. Other aspects and features are also claimed and described.

### TECHNICAL FIELD

Aspects of the present disclosure relate generally to wireless communication systems, and more particularly, to multi-channel access with respect to sidelink communication based on user equipment (UE) capability. Some features may enable and provide improved communications, including transmission of a single physical sidelink control channel (PSCCH) and physical sidelink shared channel (PSSCH) or physical sidelink broadcast channel (PSBCH) over multiple channel bandwidths within a slot and/or transmission of multiples of PSCCH/PSSCH, PSBCH, and/or physical uplink shared channel (PUSCH) over multiple channel bandwidths within a slot.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Channel access procedures for transmission on multiple channels in unlicensed bands, for example, have been developed in new radio (NR) networks, such as to facilitate increased data throughput, reduced latency, etc. with respect to communication between a base station and one or more UEs served by the base station. Multi-channel access is a procedure for simultaneously accessing different 20 MHz channel bandwidths. According to existing NR unlicensed spectrum (NR-U) operation, a next generation node B (gNB) may implement downlink multi-channel access in which the gNB may transmit using all or a subset of the multiple channel bandwidths. Also, a UE may implement uplink multi-channel access in which the UE transmits using all of the multiple channel bandwidths (i.e., all-or-nothing access) according to existing NR-U operation.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication may include identifying a resource block (RB) set configuration for sidelink unlicensed spectrum (SL-U) multi-channel access. The RB set configuration may, for example, comprise a plurality of RB sets including a different RB set for each channel bandwidth of multiple channel bandwidths available for utilization by a SL-U multi-channel access procedure implemented by a user equipment (UE) based upon one or more capability of the UE for the SL-U multi-channel access. The method may also include performing listen-before-transmitting (LBT) procedures with respect to each channel bandwidth of the multiple channel bandwidths available for utilization by the SL-U multi-channel access procedure for the SL-U multi-channel access. Further, the method may include transmitting at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

In an additional aspect of the disclosure, an apparatus includes at least one processor and a memory coupled to the at least one processor. The at least one processor may be configured to identify a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The at least one processor may also be configured to perform LBT procedures with respect to each channel bandwidth of the multiple channel bandwidths available for utilization by the SL-U multi-channel access procedure for the SL-U multi-channel access. Further, the at least one processor may be configured to transmit at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

In an additional aspect of the disclosure, an apparatus may include means for identifying a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The apparatus may also include means for performing LBT procedures with respect to each channel bandwidth of the multiple channel bandwidths available for utilization by the SL-U multi-channel access procedure for the SL-U multi-channel access. Further, the apparatus may include means for transmitting at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

In an additional aspect of the disclosure, a non-transitory computer-readable medium stores instructions that, when executed by a processor, cause the processor to perform operations. The operations may include identifying a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The operation may also include performing LBT procedures with respect to each channel bandwidth of the multiple channel bandwidths available for utilization by the SL-U multi-channel access procedure for the SL-U multi-channel access. Further, the operations may include transmitting at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

In one aspect of the disclosure, a method for wireless communication may include identifying a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The method may also include transmitting, to the UE, one or more scheduling grant including the RB set configuration.

In an additional aspect of the disclosure, an apparatus includes at least one processor and a memory coupled to the at least one processor. The at least one processor may be configured to identify a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a user equipment (UE) based upon one or more capability of the UE for the SL-U multi-channel access. The at least one processor may also be configured to transmit, to the UE, one or more scheduling grant including the RB set configuration.

In an additional aspect of the disclosure, an apparatus may include means for identifying a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The apparatus may also include means for transmitting, to the UE, one or more scheduling grant including the RB set configuration.

In an additional aspect of the disclosure, a non-transitory computer-readable medium stores instructions that, when executed by a processor, cause the processor to perform operations. The operations may include identifying a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access. The operations may also include transmitting, to the UE, one or more scheduling grant including the RB set configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example bandwidth part (BWP) comprising multiple channel bandwidths for multi-channel access according to one or more aspects.

FIGS. 4A and 4B illustrate a user equipment (UE) providing peer-to-peer sidelink communication of a sidelink channel using a sidelink unlicensed spectrum (SL-U) multi-channel access procedure according to one or more aspects.

FIGS. 5A and 5B illustrate a UE providing communication of multiple sidelink channels using a SL-U multi-channel access procedure according to one or more aspects.

FIGS. 6A and 6B illustrate a UE providing communication of multiple sidelink channels and communication of an uplink channel using a SL-U multi-channel access procedure according to one or more aspects.

FIGS. 7A and 7B illustrate a UE performing listen-before-transmitting (LBT) procedures with respect to each channel bandwidth of channel bandwidths available for utilization by a SL-U multi-channel access procedure according to one or more aspects.

FIGS. 8A-8C illustrate operation of SL-U multi-channel access procedures providing all-or-nothing access with respect to the multiple channel bandwidths of the SL-U multi-channel access according to one or more aspects.

FIGS. 9A and 9B illustrate operation of SL-U multi-channel access procedures providing partial access for a single sidelink channel on multiple channel bandwidths of the SL-U multi-channel access according to one or more aspects.

FIGS. 10A-10C illustrate operation of SL-U multi-channel access procedures providing partial access for multiple sidelink channels on multiple channel bandwidths of the SL-U multi-channel access according to one or more aspects.

FIG. 11 illustrates operation of SL-U multi-channel access procedures providing partial access for one or more multiple sidelink channels and all-or-nothing access for one or more sidelink channels on multiple channel bandwidths of the SL-U multi-channel access according to one or more aspects.

FIGS. 12A-12D illustrate operation of SL-U multi-channel access procedures providing partial access for one or more sidelink channels and an uplink channel on multiple channel bandwidths is provided based upon results of LBT procedures performed with respect to each of the channel bandwidths according to one or more aspects.

FIG. 13 illustrates an example providing for multiple sidelink channel transmission based upon channel bandwidths of the multiple channel bandwidths that clear respective LBT procedures according to one or more aspects.

FIG. 14 illustrates an example providing for sidelink channel transmission with respect to a sidelink channel spanning more than one channel bandwidth based upon channel bandwidths of the multiple channel bandwidths that clear respective LBT procedures according to one or more aspects.

FIGS. 15A-15D illustrate examples providing for sidelink channel transmission with respect to a sidelink channel spanning more than one channel bandwidth based upon channel bandwidths of the multiple channel bandwidths that clear respective LBT procedures according to one or more aspects.

FIGS. 16A and 16B illustrate examples providing for sidelink channel transmission with respect to a sidelink channel spanning more than one channel bandwidth based upon channel bandwidths of the multiple channel bandwidths that clear respective LBT procedures according to one or more aspects.

FIGS. 17A-17D illustrate an example in which a sidelink channel transmission SL-U multi-channel access procedure operates to prepare different versions of the sidelink channel according to one or more aspects.

FIG. 18 is a flow diagram illustrating an example process that supports SL-U multi-channel access operation by a UE according to one or more aspects.

FIG. 19 is a block diagram of an example UE that supports SL-U multi-channel access according to one or more aspects.

FIG. 20 is a flow diagram illustrating an example process that supports SL-U multi-channel access operation by a base station according to one or more aspects.

FIG. 21 is a block diagram of an example base station that supports SL-U multi-channel access according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Aspects of the present disclosure enable and provide multi-channel access with respect to sidelink communication based on user equipment (UE) capability. For example, in accordance with some aspects, a UE providing sidelink transmission (sidelink TX UE) may implement sidelink unlicensed spectrum (SL-U) operation in which a multi-channel access procedure facilitates simultaneous access with respect to a plurality of different channel bandwidths in the unlicensed spectrum (e.g., different 20 MHz channel bandwidths).

Implementation of a particular multi-channel access procedure for SL-U operation may be based on one or more aspect of UE capability (e.g., capabilities of a SL-U sidelink TX UE (SL-U TX UE) and/or a UE receiving sidelink communication in unlicensed spectrum (SL-U RX UE)). As an example, implementation of a particular SL-U multi-channel access procedure (e.g., providing for single sidelink channel transmission, providing for multiple sidelink channel transmission, providing for all-or-nothing SL-U multi-channel access, providing for partial multi-channel access, providing for a combination of partial multi-channel access and all-or-nothing SL-U multi-channel access, etc.) may be tied to or otherwise based upon UE capability for multiple simultaneous transmissions (e.g., if the UE can simultaneously transmit multiple sidelink channels, such as multiple physical sidelink control channels (PSCCHs)/physical sidelink shared channels (PSSCHs), physical sidelink broadcast channels (PSBCHs), or a mix of PSCCH(s)/PSSCH(s) and/or PSBCH(s), and physical uplink shared channel (PUSCH), then a SL-U multi-channel access procedure providing for partial multi-channel access may be implemented, otherwise an all-or-nothing SL-U multi-channel access procedure may be implemented). According to a further example, implementation of a particular multi-channel access procedure (e.g., providing for single sidelink channel transmission, providing for multiple sidelink channel transmission, providing for all-or-nothing SL-U partial multi-channel access, providing for partial multi-channel access, etc.) may be tied to or otherwise based upon UE capability other than and/or independent from UE capability for multiple simultaneous transmissions (e.g., a UE capability to simultaneously process data of multiple sidelinks, a UE capability to perform multiple simultaneous listen-before-transmitting (LBT) procedures, a UE capability to utilize resources allocated for SL-U multi-channel access, etc.).

In accordance with some examples, SL-U multi-channel access may facilitate transmission of a single sidelink channel (e.g., single PSCCH/PSSCH or PSBCH) over multiple channel bandwidths within a slot. According to further examples, SL-U multi-channel access may facilitate transmission of multiple sidelink channels (e.g., multiples of PSCCH/PSSCH, PSBCH, and/or PUSCH) over multiple channel bandwidths within a slot. The SL-U multi-channel transmission of some aspects of the disclosure may implement all-or-nothing multi-channel access in which the SL-U TX UE transmits one or more sidelink channels (e.g., single PSCCH/PSSCH, single PSBCH; multiples of PSCCH/PSSCH, PSBCH, and/or PUSCH) using all of the multiple channel bandwidths or does not transmit the SL-U multi-channel transmission. The SL-U multi-channel transmission of some aspects of the disclosure may implement partial multi-channel access in which the SL-U TX UE transmits partial sidelink channels of one or more sidelink channels (e.g., some portion of a single PSCCH/PSSCH or PSBCH; some portion of one or more channel of PSCCH/PSSCH, PSBCH, and/or PUSCH) using any available channel bandwidths of the multiple channel bandwidths. Determinations regarding all-or-nothing SL-U multi-channel access transmission and/or channels of partial SL-U multi-channel transmission may, for example, be tied to or otherwise based upon channel bandwidths of the multiple channel bandwidths that clear respective LBT procedures.

Particular implementations of the subject matter described in this disclosure may be implemented to realize one or more of the following potential advantages or benefits. In some aspects, the present disclosure provides techniques for SL-U multi-channel access operation by UEs configured for various capabilities. For example, UEs having multiple simultaneous transmissions capability as well as UEs not having multiple simultaneous transmissions capability may be provided one or more SL-U multi-channel access procedures according to aspects of the disclosure. Some features may enable and provide improved communications with respect to sidelink communication between UEs, including communication of a single sidelink channel (e.g., PSCCH/PSSCH or PSBCH) over a wideband channel (e.g., a single transport block (TB) using multiple resource block (RB) sets of multiple different channel bandwidths in the unlicensed spectrum). Transmission of a single sidelink channel according to a SL-U multi-channel access procedure of examples of the disclosure may facilitate various improved sidelink communications, such as in situations implementing peer-to-peer communications (e.g., broadcast or point-to-point communications). Additionally or alternatively, some features may enable and provide improved communications with respect to sidelink communication between UEs (e.g., PSCCH/PSSCH or PSBCH) and/or sidelink communication between UEs and between a base station and a UE (e.g., PUSCH), including communication of multiple channels (e.g., multiples of PSCCH/PSSCH, PSBCH, and/or PUSCH) over a wideband channel (e.g., multiple TBs using multiple RB sets of multiple different channel bandwidths in the unlicensed spectrum). Transmission of multiple channels (e.g., multiples of PSCCH/PSSCH, PSBCH, and/or PUSCH) according to a SL-U multi-channel access procedure of examples of the disclosure may facilitate various improved sidelink communications, such as in situations in which an anchor UE (e.g., a programmable logic controller (PLC)) is transmitting to client UEs (e.g., sensors and/or actuators).

As should be appreciated from the above, this disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

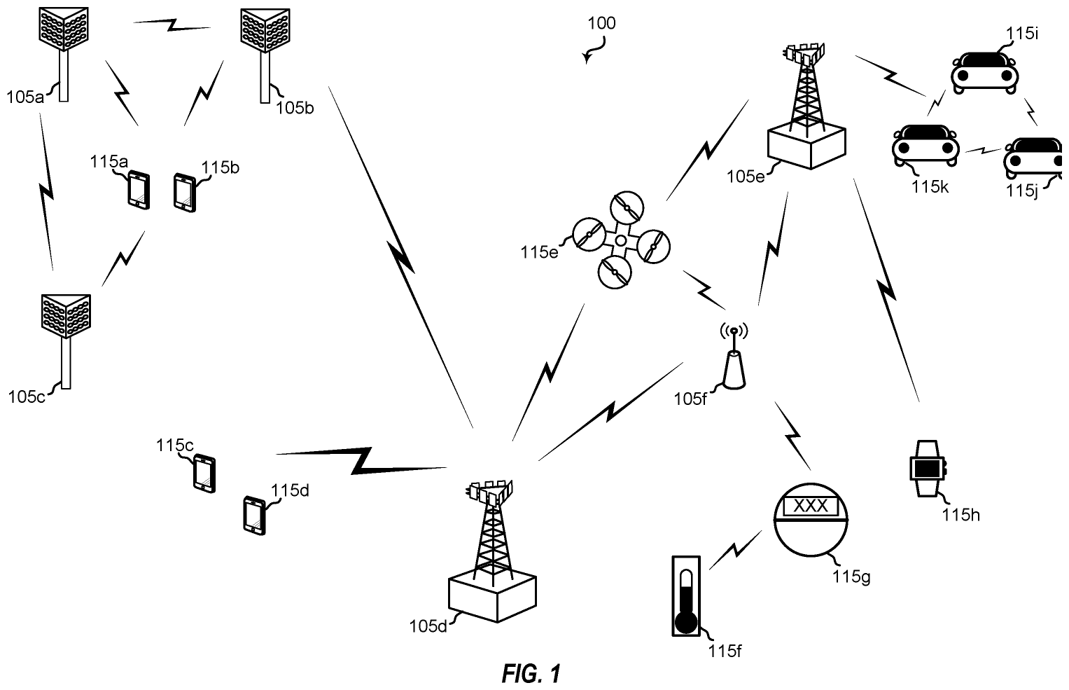

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

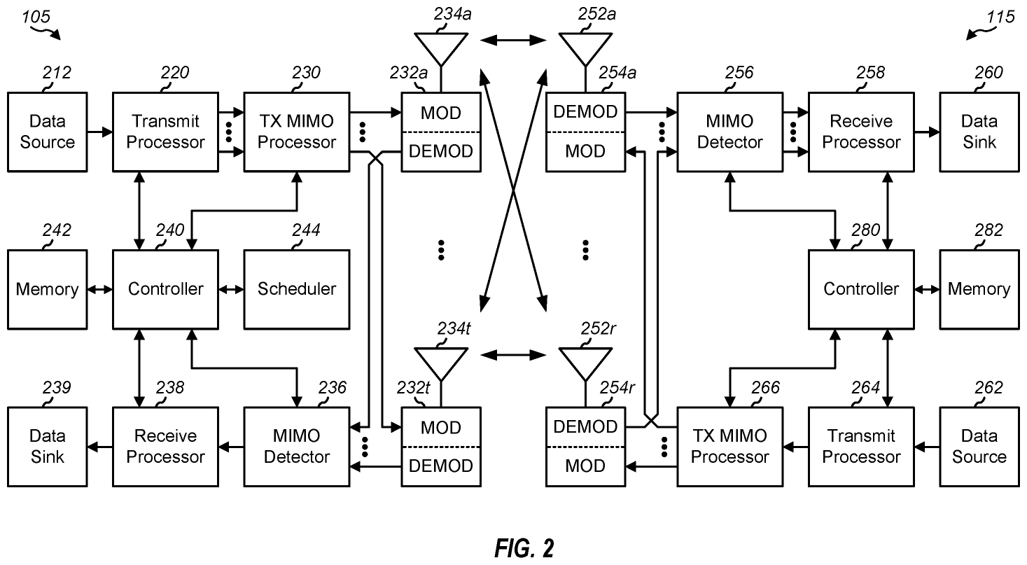

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a PUSCH) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

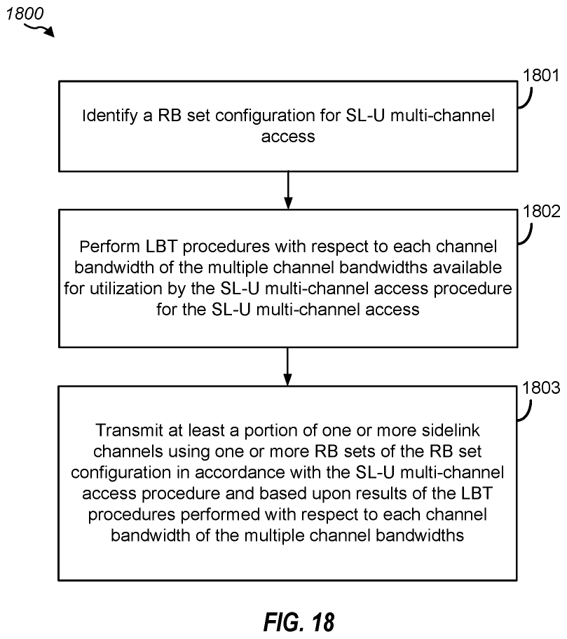

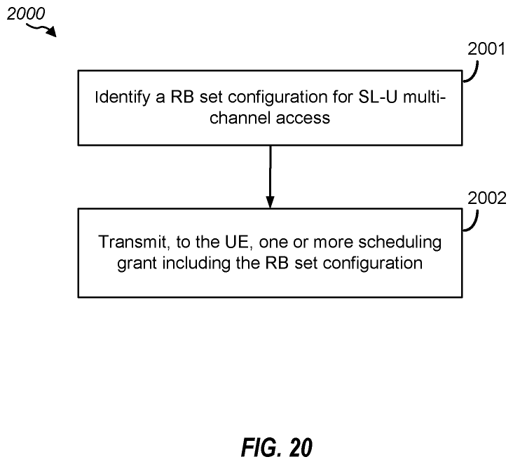

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 18 and 20, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, a LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

NR unlicensed spectrum (NR-U) operation provides a multi-channel access procedure for transmission on multiple channels in unlicensed bands. A gNB implementing multi-channel access according to NR-U operation provides downlink multi-channel access in which the gNB may transmit using all or a subset of the multiple channels. A UE implementing multi-channel access according to NR-U operation provides uplink multi-channel access in which the UE transmits using all of the multiple channels (i.e., all-or-nothing access).

NR-U operation is configured to coexist with WiFi in 5 GHz and 6 GHz bands by using a 20 MHz basic channel access unit in correspondence with the WiFi channel access 20 MHz unit. Accordingly, multi-channel access according to NR-U operation provides for simultaneously accessing different 20 MHz channels, wherein the RBs in each channel bandwidth of the 20 MHz channels are referred to as a RB set.

Multi-channel access according to NR-U operation is a procedure based on LBT. In particular, NR-U multi-channel access uses independent Type 1 LBT (e.g., a LBT procedure in which a NR-U base station or UE must back off according to a channel sense multiple access with collision avoidance (CSMA/CA) procedures with exponential backoff) on each RB set for identifying channel bandwidths available for multi-channel access.

SL-U operation according to aspects of the present disclosure provide a SL-U multi-channel access procedure for simultaneous access with respect to a plurality of different channel bandwidths in the unlicensed spectrum supporting direct UE to UE communication. SL-U multi-channel access procedures of aspects of the disclosure one or more LBT procedures with respect to channel bandwidths available for SL-U multi-channel access. For example, a SL-U multi-channel access procedure may use In particular, NR-U multi-channel access uses LBT procedures on each RB set of a SL-U RB set configuration to identify channel bandwidths available for multi-channel access.

SL-U multi-channel access procedures of some examples utilize aspects of NR-U operation configuration to facilitate implementation within NR networks. For example, SL-U multi-channel access procedures may utilize a same LBT procedure (e.g., Type 1) as utilized in NR-U operation. As another example, SL-U multi-channel access procedures may use a 20 MHz channel access unit (e.g., a plurality of different 20 MHz channel bandwidths) corresponding to that of NR-U operation.

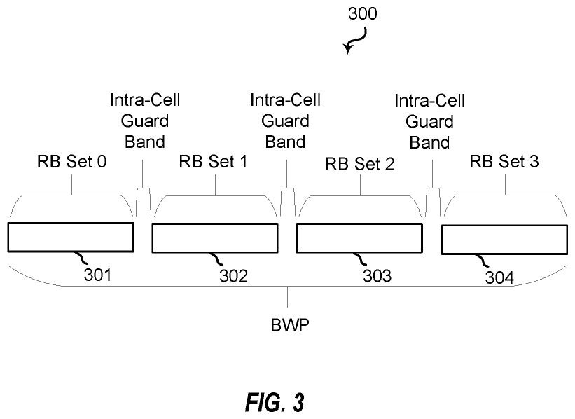

FIG. 3 shows an example bandwidth part (BWP) comprising multiple channel bandwidths for multi-channel access, such as may be used in SL-U operation as well as NR-U operation. The illustrated BWP includes channel bandwidths 301-304 (e.g., each comprising 20 MHz channel bandwidths), wherein neighboring channel bandwidths are separated by a corresponding guard band (e.g., a first guard band disposed between neighboring channel bandwidths 301 and 302, a second guard band disposed between neighboring channel bandwidths 302 and 303, and a third guard band disposed between neighboring channel bandwidths 303 and 304. The RBs available in each channel bandwidth comprise an RB set (e.g., RB Set 0 in channel bandwidth 301, RB Set 1 in channel bandwidth 302, RB Set 2 in channel bandwidth 303, and RB Set 3 in channel bandwidth 304), wherein the RB sets of the multiple channel bandwidths for multi-channel access comprise RB configuration 300.

It should be appreciated that, the BWP of FIG. 3 is one example of a BWP and RB configuration. A BWP for multi-channel access according to aspects of the disclosure may include more or fewer channel bandwidths and/or more or fewer RB sets than those of the example illustrated in FIG. 3.

According to NR-U operation, a gNB configures downlink and/or uplink RB sets per UE. For example, the RB sets may be derived from intra-cell guard band signaling (e.g., intra-cell guard bands configured by intraCellGuardBandDL-r16 or intraCellGuardBandUL-r16). SL-U operation according to some examples may configure RB sets of RB configuration 300 via gNB or other network element signaling (e.g., utilizing the same or similar technique for deriving RB sets as above) for a SL-U multi-channel access procedure. Additionally or alternatively, SL-U operation according to further examples may use one or more alternative technique for configuring RB sets for a SL-U multi-channel access procedure, such as to facilitate configuring RB sets with respect to SL-U RX UEs not in direct communication with a gNB or other network element. For example, a common RB set configuration may be provided for SL-U UEs in a network, such as via UE profile or gNB configuration (e.g., upon joining the network, upon establishing a link with the gNB, etc.). According to some examples, different UEs may have different implementations and guard band requirements could be different. Use of a common RB set configuration among UEs that are not part of a same sidelink network may result in less than maximum spectrum efficiency with respect to some or all of the SL-U links utilizing the common RB set configuration. According to another example, a RB set configuration may be provided per SL-U link, such as via radio resource control (RRC) messages. According to some aspects, distributed SL-U UE to UE communication implements a common assumption of RB set configuration to facilitate delivery of per-link RB set configurations via remaining system information (RMSI)/system information block (SIB), RRC message exchanges. Through use of a per link configuration technique of aspects of the disclosure, the RB set configuration may be refined for each SL-U link for maximum or increased spectrum efficiency.

SL-U multi-channel access procedures of aspects of the present disclosure may be configured to facilitate sidelink communication with respect to one or more use cases for SL-U multi-channel access. For example, a SL-U multi-channel access procedure may be configured for a use case in which transmission of a single sidelink channel over multiple channel bandwidths within a slot is provided. Additionally or alternatively, a SL-U multi-channel access procedure may be configured for a use case in which transmission of multiple sidelink channels over multiple channel bandwidths within a slot is provided.

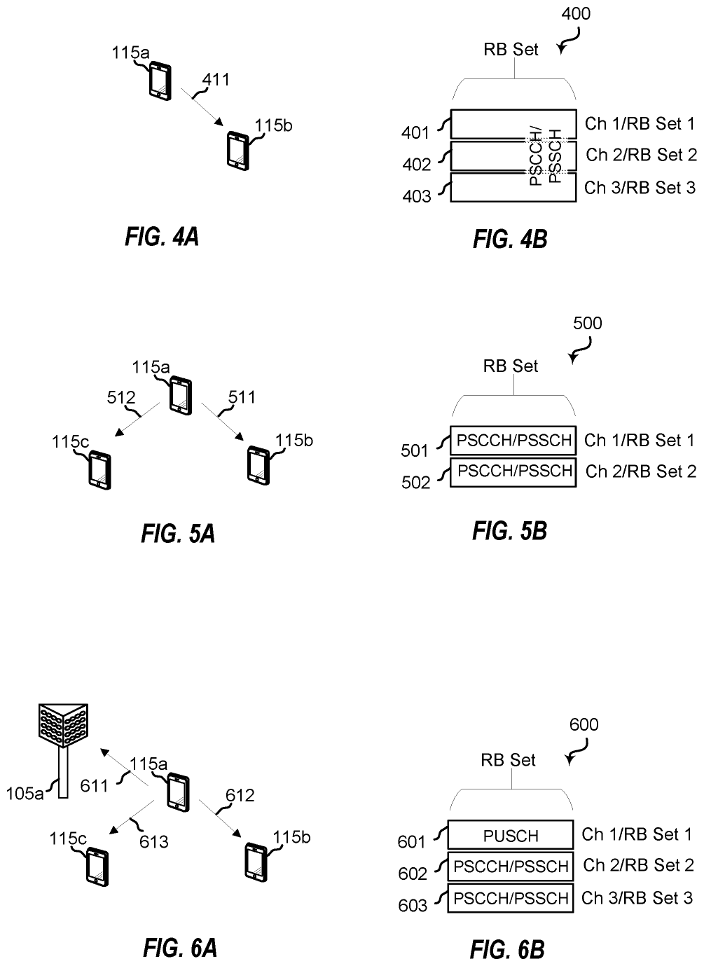

In the example use case (e.g., peer-to-peer sidelink communication) of FIGS. 4A and 4B, UE 115a transmits a single sidelink channel to UE 115b using a SL-U multi-channel access procedure. In the illustrated example, RB set configuration 400, such as may be as described with respect to RB set configuration 300 of FIG. 3, comprises RB Set 1, RB Set 2, and RB Set 3 of channel bandwidths 401, 402, and 403 respectively. In operation according to the SL-U multi-channel access procedure of this example, UE 115a transmits a single sidelink channel (e.g., a single TB comprising a single PSCCH/PSSCH or PSBCH) over wideband channel 411 to UE 115b using RB sets RB Set 1, RB Set 2, and RB Set 3.

In the example use case (e.g., anchor UE transmitting to client UEs) of FIGS. 5A and 5B, UE 115a transmits multiple sidelink channels to UE 115b and UE 115c using a SL-U multi-channel access procedure. In the illustrated example, RB set configuration 500, such as may be as described with respect to RB set configuration 300 of FIG. 3, comprises RB Set 1 and RB Set 2 of channel bandwidths 501 and 502 respectively. In operation according to the SL-U multi-channel access procedure of this example, UE 115a transmits a sidelink channel (e.g., a single TB comprising a PSCCH/PSSCH or PSBCH) over channel 511 to UE 115b using RB Set 1, and transmits a sidelink channel (e.g., a single TB comprising a PSCCH/PSSCH or PSBCH) over channel 512 to UE 115c using RB Set 2.

In the example use case (e.g., combined SL-U and NR-U operation) of FIGS. 6A and 6B, UE 115a transmits multiple sidelink channels to UE 115b and UE 115c and an uplink channel to base station 105 using a SL-U multi-channel access procedure. In the illustrated example, RB set configuration 600, such as may be as described with respect to RB set configuration 300 of FIG. 3, comprises RB Set 1, RB Set 2, and RB Set 3 of channel bandwidths 601, 602, and 603 respectively. In operation according to the SL-U multi-channel access procedure of this example, UE 115a transmits an uplink channel over channel 611 to base station 105a, transmits a sidelink channel (e.g., a single TB comprising a PSCCH/PSSCH or PSBCH) over channel 612 to UE 115b using RB Set 2, and transmits a sidelink channel (e.g., a single TB comprising a PSCCH/PSSCH or PSBCH) over channel 613 to UE 115c using RB Set 3.

UEs implementing SL-U multi-channel access procedures (e.g., SL-U TX UEs and/or SL-U RX UEs) may have different capabilities with respect to SL-U operation. Selection and/or implementation of a SL-U multi-channel access procedure according to aspects of the present disclosure may be based on UE capability (e.g., UE capability for multiple simultaneous transmissions, UE capability to simultaneously process data of multiple sidelink, UE capability to perform multiple simultaneous LBT procedures, UE capability to utilize resources allocated for SL-U multi-channel access, etc.). According to some examples, a particular SL-U multi-channel access procedure may be implemented by a UE based upon one or more capability of the UE for the SL-U multi-channel access.

According to an example, capability for multi-channel access according to one or more SL-U multi-channel access procedures may be tied to or otherwise based upon UE capability with respect to multiple simultaneous transmissions. If the UE can simultaneously transmit multiple channels (e.g., multiple PSCCH/PSSCHs and/or PSBCH or a mix of PSCCH/PSSCH and/or PSBCH and PUSCH), then the UE may implement a first SL-U multi-channel access procedure (e.g., a SL-U multi-channel access procedure providing for partial multi-channel access), otherwise the UE may implement a second SL-U multi-channel access procedure (e.g., a SL-U multi-channel access procedure providing all-or-nothing multi-channel access). Additionally or alternatively, capability for multi-channel access according to one or more SL-U multi-channel access procedures may be independent from capability with respect to multiple simultaneous transmissions. For example, a SL-U multi-channel access procedure may be selected, at least in part, for implementation by a UE based on capabilities UE capability to simultaneously process data of multiple sidelink, UE capability to perform multiple simultaneous LBT procedures, UE capability to utilize resources allocated for SL-U multi-channel access, etc.

As should be appreciated from the foregoing, there may be different levels of UE capability to handle different cases. For example, a UE may implement a particular SL-U multi-channel access procedure based upon one or more capability of the UE for the SL-U multi-channel access comprising a first UE capability or a second UE capability (e.g., particular first and second UE capabilities, UE capabilities meeting first and second levels of capability, UE capabilities corresponding to first and second categories of capability, etc.).

In operation according to some examples, information regarding UE capability with respect to SL-U multi-channel access may be signaled between various devices (e.g., between a SL-U TX UE and one or more SL-U RX UE, between a SL-U TX UE and a base station, between a SL-U RX UE and a base station, etc.). For example, capability to perform multiple simultaneous sidelink transmissions may be a UE capability signaled via RRC according to aspects. Additionally or alternatively, capability to perform simultaneous sidelink transmissions and uplink transmissions may be a UE capability signaled via RRC. As a further example, capability to perform multiple simultaneous LBT procedures may additionally or alternatively be a UE capability signaled via RRC. A device (e.g., base station or SL-U TX UE) to which another device (e.g., SL-U TX UE, SL-U RX UE) provides UE capability information may use the capability information to provide scheduling grants (e.g., multiple sidelink transmission mode 1 (Mode 1) sidelink grants, Mode 1 sidelink grants and uplink grants, etc.) or otherwise selecting or scheduling resources (e.g., sidelink transmission mode 2 (Mode 2) scheduling assignments) for simultaneous transmissions of SL-U multi-channel access.

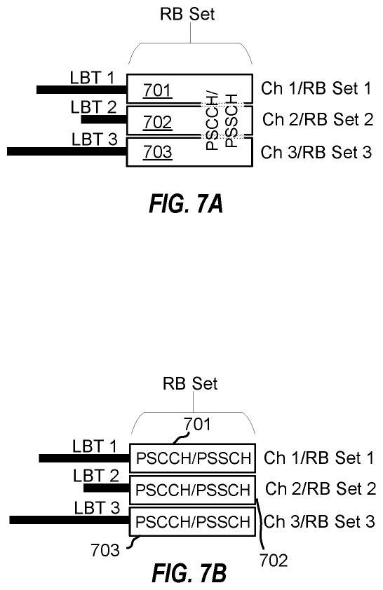

According to some examples, a first UE capability for SL-U multi-channel access may support transmission of a single sidelink channel (e.g., PSCCH/PSSCH or PSBCH) without supporting simultaneous transmission of multiple sidelink channels (e.g., a low capability UE). According to aspects of the disclosure, a low capability UE may implement a single sidelink channel transmission SL-U multi-channel access procedure based at least in part on this capability of the UE. Due to the relatively restricted capability of the UE sending a single sidelink channel in a slot, the single sidelink channel transmission SL-U multi-channel access procedure implemented by the low capability UE may provide all-or-nothing SL-U multi-channel access (e.g. the UE transmits the single sidelink channel using all of the multiple channel bandwidths or does not transmit the single sidelink channel). In operation according to a single sidelink channel transmission SL-U multi-channel access procedure implemented by an example low capability UE, as shown in FIG. 7A, the UE may perform LBT procedures (e.g., independently perform procedures LBT 1, LBT 2, and LBT 3) with respect to each channel bandwidth (e.g., channel bandwidths 701, 702, and 703) of the channel bandwidths available for utilization by the SL-U multi-channel access procedure. A SL-U TX UE of this example may transmit the single sidelink channel (e.g., PSCCH/PSSCH or PSBCH) when the UE has access to all the channel bandwidths (e.g., channel bandwidths 701, 702, and 703 each clear respective LBT procedures).

SL-U multi-channel access procedures implemented by examples of a UE having a first UE capability for SL-U multi-channel access (e.g., a low capability UE) are not limited to single sidelink channel transmission SL-U multi-channel access procedures. For example, a low capability UE may implement a multiple sidelink channel transmission SL-U multi-channel access procedure based at least in part on this capability of the UE. Due to the relatively restricted capability of the UE of this example, the multiple sidelink channel transmission SL-U multi-channel access procedure implemented by the low capability UE may provide all-or-nothing SL-U multi-channel access (e.g., the UE transmits all of the multiple sidelink channels using all of the multiple channel bandwidths or does not transmit any of the multiple sidelink channels). As in the previous example, in operation according to a multiple sidelink channel transmission SL-U multi-channel access procedure implemented by an example low capability UE, the UE may perform LBT procedures with respect to each channel bandwidth and transmit the multiple sidelink channels when the UE has access to all the channel bandwidths.

According to some examples, a second UE capability for SL-U multi-channel access may support simultaneous transmission of multiple sidelink channels (e.g., a high capability UE). According to aspects of the disclosure, a high capability UE may implement a multiple sidelink channel transmission SL-U multi-channel access procedure based at least in part on this capability of the UE. Due to the relatively advanced capability of the UE sending multiple sidelink channels in a slot, the multiple sidelink channel transmission SL-U multi-channel access procedure implemented by the high capability UE may provide partial SL-U multi-channel access (e.g. the UE transmits on the channel bandwidths that clear respective LBT procedures). In operation according to a multiple sidelink channel transmission SL-U multi-channel access procedure implemented by an example high capability UE, as shown in FIG. 7B, the UE may perform LBT procedures (e.g., independently perform procedures LBT 1, LBT 2, and LBT 3) with respect to each channel bandwidth (e.g., channel bandwidths 701, 702, and 703) of the channel bandwidths available for utilization by the SL-U multi-channel access procedure. A SL-U TX UE of this example may transmit sidelink channels (e.g., PSCCH/PSSCH or PSBCH) of the multiple sidelink channels when the UE has access to respective channel bandwidths (e.g., channel bandwidths 701, 702, and 703 that clear respective LBT procedures).

According to another example, a second UE capability for SL-U multi-channel access may support transmission of an uplink channel to a base station simultaneously with transmission of one or more sidelink channels (e.g., a high capability UE). As in the previous example, in operation according to a multiple uplink/sidelink channel transmission SL-U multi-channel access procedure implemented by an example high capability UE, the UE may perform LBT procedures with respect to each channel bandwidth and transmit the uplink channel and/or sidelink channels when the UE has access to the respective channel bandwidths.

SL-U multi-channel access procedures implemented by examples of a UE having a second UE capability for SL-U multi-channel access (e.g., a high capability UE) are not limited to multiple sidelink channel transmission SL-U multi-channel access procedures. For example, a high capability UE may implement a single sidelink channel transmission SL-U multi-channel access procedure based at least in part on this capability of the UE. Due to the relatively advanced capability of the UE of this example, the single sidelink channel transmission SL-U multi-channel access procedure implemented by the high capability UE may operate to puncture and rate-match a sidelink channel according to available resources (e.g., RB sets of channel bandwidths clearing respective LBT procedures). The single sidelink channel transmission SL-U multi-channel access procedure implemented by the high capability UE may additionally or alternatively operate to prepare different versions of the sidelink channel, and use a particular one of the versions according to available resources (e.g., RB sets of channel bandwidths clearing respective LBT procedures).

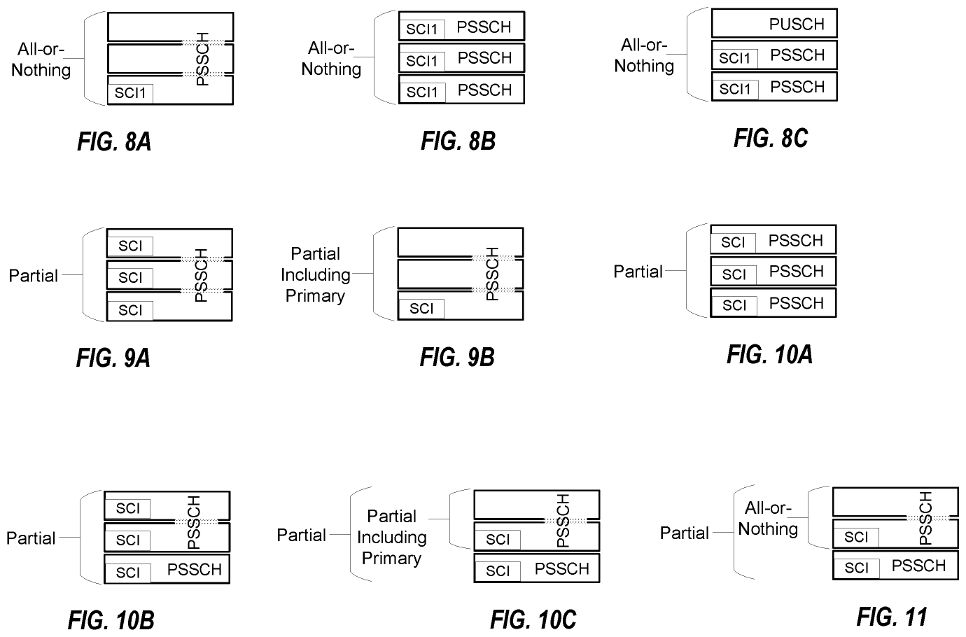

FIGS. 8A-8C, 9A and 9B, 10A-10C, 11, and 12A-12D illustrate examples of various SL-U multi-channel access procedures according to concepts of the present disclosure. The examples of these figures illustrate operation of a SL-U multi-channel access procedure for SL-U UEs based on UE capability.

FIGS. 8A-8C illustrate operation of SL-U multi-channel access procedures providing all-or-nothing access with respect to the multiple channel bandwidths of the SL-U multi-channel access. According to the examples of FIGS. 8A-8C, all-or-nothing transmission (e.g., using RB sets of all channel bandwidths when each channel bandwidth clears their respective LBT procedures) of a single sidelink channel may be provided based upon results of LBT procedures performed with respect to each of the channel bandwidths.

In the example of FIG. 8A, all-or-nothing access for single sidelink channel (e.g. PSCCH/PSSCH or PSBCH) on multiple channel bandwidths is provided based upon results of LBT procedures performed with respect to each of the channel bandwidths. The example of FIG. 8A may, for example, be implemented by UEs which do not have a capability for multiple simultaneous transmissions.

In the example of FIG. 8B, all-or-nothing access for multiple sidelinks (e.g., PSCCH/PSSCHs and/or PSBCHs) on multiple channel bandwidths is provided based upon results of LBT procedures performed with respect to each of the channel bandwidths. The example of FIG. 8B may, for example, be implemented by UEs which do not have a capability for multiple simultaneous transmissions but which do have a capability to simultaneously process data of multiple sidelinks and/or by UEs having a capability for multiple simultaneous transmissions and a capability to simultaneously process data of multiple transmissions.

In the example of FIG. 8C, all-or-nothing access for one or more sidelink channels (e.g., PSCCH/PSSCH(s) and/or PSBCH(s)) and an uplink channel (e.g., PUSCH) on multiple channel bandwidths is provided based upon results of LBT procedures performed with respect to each of the channel bandwidths. The example of FIG. 8B may, for example, may be implemented by UEs having a capability for multiple simultaneous transmissions, a capability for simultaneous transmission of sidelink and uplink channels, and a capability to simultaneously process data of multiple transmissions.

FIGS. 9A and 9B illustrate operation of SL-U multi-channel access procedures providing partial access for a single sidelink channel (e.g., PSCCH/PSSCH or PSBCH) on multiple channel bandwidths of the SL-U multi-channel access. According to the examples of FIGS. 9A and 9B, partial transmission (e.g., using RB sets of channel bandwidths clearing their respective LBT procedures) of a single sidelink channel may be provided based upon results of LBT procedures performed with respect to each of the channel bandwidths.

In the example of FIG. 9A, SCI (e.g., SCI-1 and/or SCI-2) may be repeated on the allocation for each channel bandwidth used for transmission of a portion of the sidelink channel to facilitate transmission of portions of the sidelink channel using RB sets of any channel bandwidth that clears their LBT procedure. In the example of FIG. 9B, SCI (e.g., SCI-1 and/or SCI-2) may be contained on a primary portion of the sidelink channel, wherein if the channel bandwidth for that portion clears an associated LBT procedure the transmission of one or more portions of the sidelink channel is provided (e.g., partial access can happen on one or more channel bandwidths, such as those that contain SCIs, those that clear their LBT procedures, etc.). The examples of FIGS. 9A and 9B may, for example, be implemented by UEs which do not have a capability for multiple simultaneous transmissions. UEs implementing the examples of FIGS. 9A and 9B may additionally have a capability to puncture the sidelink channel resources and do rate matching for facilitating partial sidelink channel transmission. According to some examples, the UE may have a capability to create multiple redundancy versions for the PSSCH, based on capability, and select the appropriate version for transmission based upon results of LBT procedures performed with respect to each of the channel bandwidths.

FIGS. 10A-10C illustrate operation of SL-U multi-channel access procedures providing partial access for multiple sidelink channels (e.g., multiples of PSCCH/PSSCHs and/or PSBCHs) on multiple channel bandwidths of the SL-U multi-channel access. According to the examples of FIGS. 10A-10C, partial transmission (e.g., using RB sets of channel bandwidths clearing their respective LBT procedures) of multiple sidelink channels and/or of a particular sidelink channel may be provided based upon results of LBT procedures performed with respect to each of the channel bandwidths.

In the example of FIG. 10A, one sidelink channel is provided per channel bandwidth, wherein the sidelink channels for which their associated channel bandwidth clears its LBT procedure are transmitted. In the example of FIG. 10B, one or more sidelink channels may span more than a channel bandwidth (e.g., a hybrid of the examples of FIGS. 9A and 10A), wherein portions of sidelink channels for which their associated channel bandwidth clears its LBT procedure are transmitted. In the example of FIG. 10B, SCI (e.g., SCI-1 and/or SCI-2) may be repeated on the allocation for each channel bandwidth used for transmission of a portion of the sidelink channel to facilitate transmission of portions of the sidelink channels using RB sets of any channel bandwidth that clears their LBT procedure. The examples of FIGS. 10A and 10B may, for example, be implemented by UEs which have a capability for multiple simultaneous transmissions and which have a capability to simultaneously process data of multiple sidelinks.

In the example of FIG. 10C, one or more sidelink channels may span more than channel bandwidth (e.g., a hybrid of the examples of FIGS. 9B and 10A), wherein portions of sidelink channels for which their associated channel bandwidth clears its LBT procedure are transmitted. In the example of FIG. 10C, SCI (e.g., SCI-1 and/or SCI-2) may be contained on a primary portion of a sidelink channel spanning more than one channel bandwidth, wherein if the channel bandwidth for that portion clears an associated LBT procedure the transmission of one or more portions of the sidelink channel is provided (e.g., partial access can happen on one or more channel bandwidths, such as those that contain SCIs, those that clear their LBT procedures, etc.). The example of FIG. 10C may, for example, be implemented by UEs which have a capability for multiple simultaneous transmissions and which have a capability to simultaneously process data of multiple sidelinks. UEs implementing the examples of FIGS. 10B and 10C may additionally have a capability to puncture the sidelink channel resources and do rate matching for facilitating partial sidelink channel transmission. According to some examples, the UE may have a capability to create multiple redundancy versions for the PSSCH, based on capability, and select the appropriate version for transmission based upon results of LBT procedures performed with respect to each of the channel bandwidths.

FIG. 11 illustrates operation of SL-U multi-channel access procedures providing partial access for one or more multiple sidelink channels (e.g., multiples of PSCCH/PSSCHs and/or PSBCHs) and all-or-nothing access for one or more sidelink channels (e.g., PSCCH/PSSCHs and/or PSBCHs) on multiple channel bandwidths of the SL-U multi-channel access. According to the example of FIG. 11, one or more sidelink channels may span more than channel bandwidth (e.g., a hybrid of the examples of FIGS. 8A and 10A), wherein partial access is provided for sidelink channels (e.g., per sidelink channel access) for which their associated channel bandwidth clears its LBT procedure(s), wherein all-or-nothing access is provided with respect to sidelink channels spanning multiple channel bandwidths based upon results of the LBT procedures. The example of FIG. 11 may, for example, be implemented by UEs which have a capability for multiple simultaneous transmissions and which have a capability to simultaneously process data of multiple sidelinks.

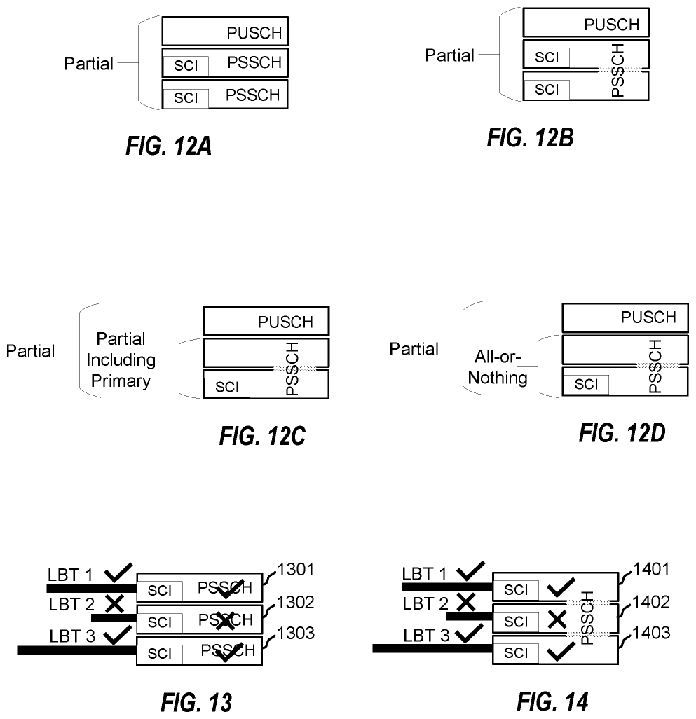

FIGS. 12A-12D illustrate operation of SL-U multi-channel access procedures providing partial access for one or more sidelink channels (e.g., multiples of PSCCH/PSSCHs and/or PSBCHs) and an uplink channel (e.g., PUSCH) on multiple channel bandwidths is provided based upon results of LBT procedures performed with respect to each of the channel bandwidths. According to the examples of FIGS. 12A-12D, partial transmission (e.g., using RB sets of channel bandwidths clearing their respective LBT procedures) of multiple sidelink channels, of a particular sidelink channel, and/or of an uplink channel may be provided based upon results of LBT procedures performed with respect to each of the channel bandwidths.

In the example of FIG. 12A, one sidelink channel or uplink channel is provided per channel bandwidth (e.g., a hybrid of the example of FIG. 10A), wherein the sidelink and uplink channels for which their associated channel bandwidth clears its LBT procedure are transmitted. In the example of FIG. 12B, one or more sidelink and/or uplink channels may span more than a channel bandwidth (e.g., a hybrid of the example of FIG. 10B), wherein portions of sidelink and/or uplink channels for which their associated channel bandwidth clears its LBT procedure are transmitted. The examples of FIGS. 12A and 12B may, for example, be implemented by UEs which have a capability for multiple simultaneous transmissions, a capability to simultaneously process data of multiple sidelinks, and a capability to perform sidelink transmissions and uplink transmissions.

In the example of FIG. 12C, one or more sidelink and/or uplink channels may span more than channel bandwidth (e.g., a hybrid of the example of FIG. 10C), wherein portions of sidelink and/or uplink channels for which their associated channel bandwidth clears its LBT procedure are transmitted. In the example of FIG. 12C, SCI (e.g., SCI-1 and/or SCI-2) may be contained on a primary portion of a sidelink channel spanning more than one channel bandwidth, wherein if the channel bandwidth for that portion clears an associated LBT procedure the transmission of one or more portions of the sidelink channel is provided (e.g., partial access can happen on one or more channel bandwidths, such as those that contain SCIs, those that clear their LBT procedures, etc.). The example of FIG. 12C may, for example, be implemented by UEs which have a capability for multiple simultaneous transmissions, a capability to simultaneously process data of multiple sidelinks, and a capability to perform simultaneous sidelink transmissions and uplink transmissions. UEs implementing the examples of FIGS. 12B and 12C may additionally have a capability to puncture the sidelink channel resources and do rate matching for facilitating partial sidelink channel transmission. According to some examples, the UE may have a capability to create multiple redundancy versions for the PSSCH, based on capability, and select the appropriate version for transmission based upon results of LBT procedures performed with respect to each of the channel bandwidths.

In the example of FIG. 12D, one or more sidelink channels and/or uplink channels may span more than channel bandwidth (e.g., a hybrid of the example of FIG. 11), wherein partial access is provided for sidelink and/or uplink channels (e.g., per sidelink/uplink channel access) for which their associated channel bandwidth clears its LBT procedure(s), wherein all-or-nothing access is provided with respect to sidelink and/or uplink channels spanning multiple channel bandwidths based upon results of the LBT procedures. The example of FIG. 12D may, for example, be implemented by UEs which have a capability for multiple simultaneous transmissions, a capability to simultaneously process data of multiple sidelinks, and a capability to perform simultaneous sidelink transmissions and uplink transmissions.

In operation according to SL-U multi-access channel procedures of aspects of the disclosure, such as the SL-U multi-access channel procedures of the examples of FIGS. 8A-8C, 9A and 9B, 10A-10C, 11, and 12A-12D described above, SL-U multi-access transmission of sidelink channels (and in some examples, uplink channels) is provided for based upon appropriate channel bandwidths clearing an associated LBT procedure. For example, a UE having a first UE capability for SL-U multi-channel access (e.g., a low capability UE) may transmit all the prepared sidelink channel transmissions (e.g., PSCCH/PSSCH(s) and/or PSBCH(s)) if all the LBT procedures in the SL-U multi-channel access procedure succeed. In a further example, a UE having a second UE capability for SL-U multi-channel access (e.g., a high capability UE) may transmit over a subset of the channel bandwidths for which the SL-U multi-channel access is performed, such as depending on the resource allocation of the transmissions, the capability of selecting or modifying a waveform after the LBT procedure, etc.

FIGS. 13, 14, 15A-15D, 16A, and 16B illustrate various implementations with respect to SL-U multi-channel access based upon results of LBT procedures for the channel bandwidths. In particular, the example of FIG. 13 illustrates an example providing for multiple sidelink channel transmission, based upon channel bandwidths of the multiple channel bandwidths that clear respective LBT procedures. The examples of FIGS. 14, 15A-15D, 16A, and 16B illustrate examples providing for sidelink channel transmission with respect to a sidelink channel spanning more than one channel bandwidth, based upon channel bandwidths of the multiple channel bandwidths that clear respective LBT procedures. It should be understood that, although the examples described with respect to FIGS. 13, 14, 15A-15D, 16A, and 16B are described separately to aid in understanding concepts of the present disclosure, the sidelink channel configurations of various of the examples may be combined (e.g., providing for transmission of multiple sidelink channels, wherein one or more sidelink channels span more than one channel bandwidth) according to aspects herein. Further, although the examples reference sidelink channel transmission, it should be understood that the concepts described apply to examples in which transmission of sidelink and uplink channels are provided. That is, in operation according to examples where the UE is capable of simultaneous sidelink and uplink transmissions, the techniques described below with reference to FIGS. 13, 14, 15A-15D, 16A, and 16B may be applied for a mix of one or more sidelink channels (e.g. PSCCH/PSSCH(s) and/or PSBCH(s)) and one or more uplink channels (e.g., PUSCH(s)).

In the example of FIG. 13, transmission is provided for sidelink channels (e.g., PSSCH/PSCCH(s) and/or PSBCH(s)) that are fully contained in respective channel bandwidths. Channel bandwidths 1301 and 1303 of the illustrated example are shown as having cleared their respective LBT procedures, whereas channel bandwidth 1302 is shown as having failed to clear its respective LBT procedure. Accordingly, the sidelink channels that are fully contained in the RB sets of channel bandwidths 1301 and 1303 may be transmitted according to the example SL-U multi-access channel procedure.

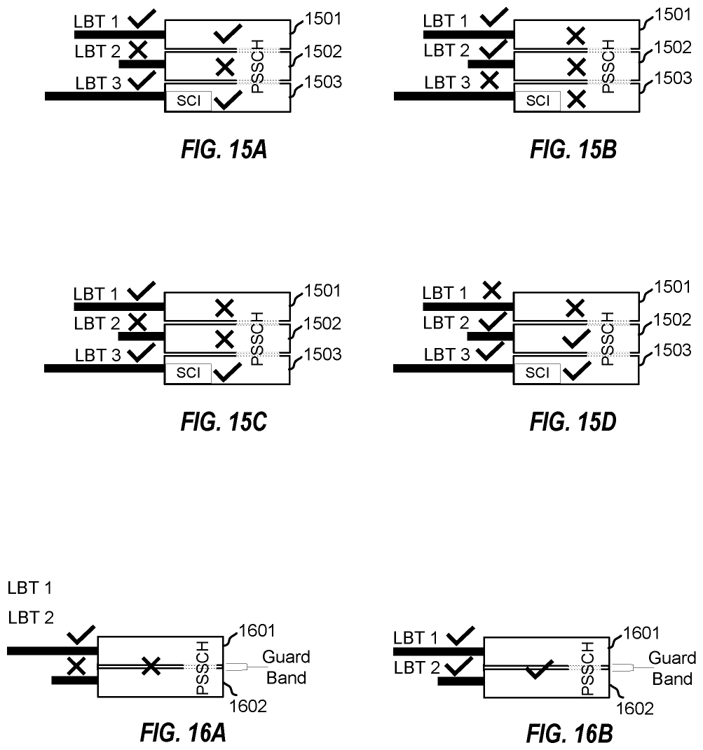

In the examples of FIGS. 14, 15A-15D, 16A, and 16B, transmission is provided for sidelink channels (e.g., PSSCH/PSCCH(s) and/or PSBCH(s)) that span more than one channel bandwidth. In particular, the sidelink channels of FIGS. 14 and 15A-15D are contained within RB sets of the channel bandwidths of the SL-U multi-channel access procedure without occupying RBs of the guard band(s). In contrast, the sidelink channels of FIGS. 16A and 16B are contained within RB sets of the channel bandwidths and RBs of the guard band(s) therebetween. The illustrated examples provide for transmissions of sidelink channels that span more channel bandwidths where respective channel bandwidths have successful LBT procedures (e.g., the LBT procedure for a channel bandwidth indicates that the channel bandwidth is clear for transmission). For the partial transmission of a sidelink channel according to some aspects of the disclosure, the UE may puncture the waveform and rate match over the available resources, excluding those over the channels that did not pass their LBT procedure.

In the example of FIG. 14, the sidelink channel is contained within RB sets of the channel bandwidths (e.g., channel bandwidths 1401-1403), and does not occupy RBs of guard bands disposed between those channel bandwidths. Partial transmission of a sidelink channel is facilitated according to this example by including SCI (e.g., SCI-1 (e.g., containing the TDRA and FDRA of that PSSCH) and/or SCI-2) in the sidelink channel portions corresponding to each of the SL-U multi-access channel bandwidths. For example, SCI may be repeated in the sidelink channel portions for each of channel bandwidths 1401-1403 to facilitate partial transmission of sidelink channel portions for which respective channel bandwidths clear their LBT procedure. According to some examples, the sidelink channel portions in each channel bandwidth may rate match around the repeated SCI.

In the examples of FIGS. 15A-15D, the sidelink channels are contained within RB sets of the channel bandwidths (e.g., channel bandwidths 1501-1503), and do not occupy RBs of guard bands disposed between those channel bandwidths. Partial transmission of a sidelink channel may be provided according to these examples if at least one of the sidelink channel portions associated with the SL-U multi-access channel bandwidths available for access contain SCI (e.g., SCI-1 (e.g., containing the TDRA and FDRA of that PSSCH) and/or SCI-2). For example, SCI may be contained in the sidelink channel portion of a primary channel bandwidth (e.g., channel bandwidth 1503). As shown in in the examples of FIGS. 15A and 15B, transmission of sidelink channel portions may be provided over the channel bandwidths for which the sidelink channel portions do not contain SCI (e.g., channel bandwidths 1502 and/or 1503) if the respective LBT procedures are successful and if the LBT procedure is successful with respect to the primary channel bandwidth (e.g., channel bandwidth 1501).

According to some aspects of the disclosure, partial transmission of a sidelink channel may be provided if the resource allocation (e.g., RB sets of the respective channel bandwidths) of the sidelink channel spanning multiple channels does not have gaps in frequency (e.g., missing a middle channel bandwidth). For example, the LBT procedure with respect to a primary channel bandwidth (e.g., 1503) corresponding to a sidelink channel portion including SCI may be successful, and the LBT procedure with respect to another channel bandwidth (e.g., channel bandwidths 1501 and/or 1502) corresponding to another portion of the sidelink channel may also be successful. Transmission of the sidelink channel portions which do not contain SCI is provided if there are no gaps in frequency (e.g., resource allocations of the SL-U multi-channel access channel bandwidths other than guard bands) between the corresponding channel bandwidths, according to this example. FIG. 15C illustrates an instance where the channel bandwidths 1501 and 1503 clear their LBT procedures, however the sidelink channel portion corresponding to channel bandwidth 1501 is not transmitted in view of the gap in frequency between the channel bandwidths for which the LBT procedures for the sidelink channel were successful. In contrast, FIG. 15D illustrates an instance where the channel bandwidths 1502 and 1503 clear their LBT procedures, and the sidelink channel portion corresponding to channel bandwidth 1502 is transmitted in view of there being no gap in frequency between the channel bandwidths (e.g., channel bandwidths 1502 and 1503 are neighboring channel bandwidths) for which the LBT procedures for the sidelink channel were successful.

As shown above, partial transmission of sidelink channels may be provided for if the resource allocation do not involve RBs in guard bands of the channel bandwidths (e.g., RB sets of the channel bandwidths available for SL-U multi-channel access) according to some aspects of the disclosure. In the examples of FIGS. 16A and 16B, the sidelink channels spanning more than one channel bandwidth are contained both within RB sets of the channel bandwidths (e.g., channel bandwidths 1601 and 1602) and RBs of the guard band(s) therebetween. According to some examples, transmission of a sidelink channel spanning multiple channel bandwidths with allocation on RBs in guard bands is provided for if a receiver UE (e.g., SL-U RX UE) has the capability of decoding a sidelink channel with allocation over RBs in guard bands. The transmission of a sidelink channel spanning multiple channels with allocation on RBs in a guard band between RB sets of different channel bandwidths of the SL-U multi-channel access may be provided according to some examples if the LBT procedures are successful for the channel bandwidths around the guard bands. For example, as shown in the example of FIG. 16A, the LBT procedure with respect to channel bandwidth 1601 was successful, but the LBT procedure with respect to neighboring channel bandwidth 1602 was not successful. The sidelink channel spanning channel bandwidths 1601 and 1602 is not transmitted in this example. In contrast, as shown in the example of FIG. 16B, the LBT procedure with respect to neighboring channel bandwidths 1601 and 1602 was successful. The sidelink channel spanning channel bandwidths 1601 and 1602 is transmitted in this example.

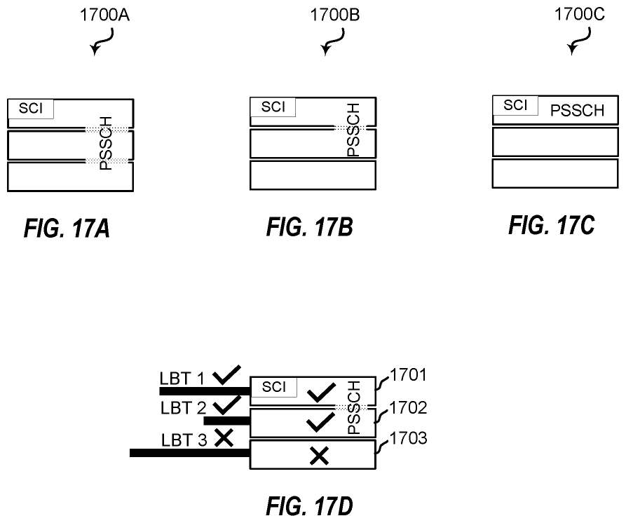

FIGS. 17A-17D illustrate an example in which a sidelink channel transmission SL-U multi-channel access procedure operates to prepare different versions of the sidelink channel. For example, versions 1700A (FIG. 17A), 1700B (FIG. 17B), and 1700C (FIG. 17C) may be prepared, such as using different modulation coding schemes (MCSs), code rates, etc., for transmission of a particular version of the sidelink channel based upon results of the LBT procedures for the channel bandwidths for the SL-U multi-channel access. For example, a particular one of the sidelink channel versions may be used according to available resources (e.g., RB sets of channel bandwidths clearing respective LBT procedures). In the example of FIG. 17D, channel bandwidths 1701 and 1702 clear their LBT procedures, whereas channel bandwidth 1703 does not clear its LBT procedure. According to this example, transmission of sidelink channel version 1700B, wherein the sidelink channel spans two channel bandwidths, is provided transmission according to the SL-U multi-channel access procedure.

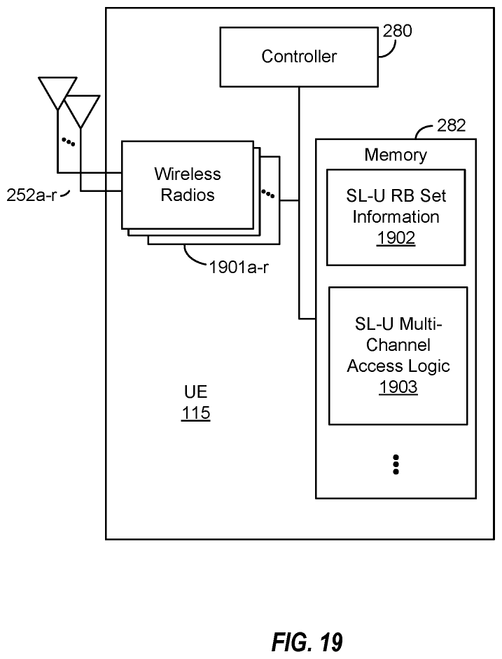

FIG. 18 is a flow diagram illustrating an example process 1800 that supports SL-U multi-channel access according to one or more aspects. Operations of process 1800 may be performed by a UE (e.g., SL-U TX UE), such as UE 115 described above with reference to FIGS. 1 and 2 or a UE described with reference to FIG. 19. For example, example operations (also referred to as “blocks”) of process 400 may enable UE 115 to support SL-U multi-channel access based upon UE capability.

In block 1801 of process 1800 illustrated in FIG. 18, the UE identifies (e.g., by operation of SL-U multi-channel access logic executed by the UE) a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by the UE based upon one or more capability of the UE for the SL-U multi-channel access.

A SL-U multi-channel access procedure may be selected for use or otherwise implemented by the UE may be based on one or more aspect of UE capability. A UE may, for example, implement a particular SL-U multi-channel access procedure based upon one or more capability of the UE for the SL-U multi-channel access comprising a first UE capability or a second UE capability (e.g., particular first and second UE capabilities, UE capabilities meeting first and second levels of capability, UE capabilities corresponding to first and second categories of capability, etc.). As an example, implementation of a particular SL-U multi-channel access procedure may be tied to or otherwise based upon UE capability for multiple simultaneous transmissions (e.g., if the UE can simultaneously transmit multiple sidelink channels or a mix of sidelink channel(s) and uplink channel). According to a further example, implementation of a particular SL-U multi-channel access procedure may be tied to or otherwise based upon UE capability other than and/or independent from UE capability for multiple simultaneous transmissions (e.g., a UE capability to simultaneously process data of multiple sidelinks, a UE capability to perform multiple simultaneous LBT procedures, a UE capability to utilize resources allocated for SL-U multi-channel access, etc.).

In accordance with some aspects, a SL-U multi-channel access procedure may be selected for use by a UE based upon one or more capability of the UE by a base station or other network entity (e.g., under control of SL-U multi-channel access logic executed by the base station), such as in association with connection to a network by the UE, in association with establishing or maintaining a communication link between the base station and UE, in association with a sidelink resource grant, in association with scheduling sidelink communications, etc. In some implementations, UE may transmit information regarding the one or more capability of a UE for the SL-U multi-channel access to the base station, wherein the base station may select a particular SL-U multi-channel access procedure for implementation by a UE and/or identify a RB set configuration for use with respect to the SL-U multi-channel access procedure based at least in part on the information received from the UE. Additionally or alternatively, a SL-U multi-channel access procedure may be selected by a UE (e.g., under control of SL-U multi-channel access logic executed by the UE) based upon one or more capability of the UE, such as in association with a sidelink resource grant, in association with scheduling sidelink communications, etc.

One or more RB set configuration for SL-U multi-channel access may, according to some examples, be stored by the UE (e.g., as SL-U RB set information in a database memory of the UE) or otherwise be available to the UE. The UE may determine, select, or otherwise identify a RB set configuration for use with respect to a SL-U multi-channel access procedure implemented by the UE.

RB set configurations may be provided as a common RB set configuration, such as via UE profile or gNB configuration (e.g., upon joining the network, upon establishing a link with the gNB, etc.). Additionally or alternatively, RB set configurations may be provided per SL-U link.

The UE may be operating as a sidelink transmission Mode 1 UE that handles one or multiple grants obtained from a base station, or operating as a sidelink transmission Mode 2 UE that creates one or multiple grants on its own. According to some examples in which a UE is operating according to sidelink transmission Mode 1, a base station may provide a RB set configuration to the UE, such as via signaling for sidelink resource grant and/or scheduling (e.g., a dynamic grant (DG) or configured grant (CG) from the base station over PDCCH (e.g., one or more DCI 3_0 information elements)). If, for example, the frequency domain resource allocation (FDRA) indicated by the Mode 1 grant spans more than one RB set, then a SL-U multi-channel access procedure is to be performed by the UE to start a channel occupancy time (COT). According to some examples in which a SL-U TX UE is operating according to sidelink transmission Mode 2, the UE may make determinations regarding the RB set configuration to be used by the UE for SL-U multi-channel access. For a sidelink transmission Mode 2 UE, a media access control (MAC) entity may indicate an amount of frequency resources and request the physical layer (PHY) to provide a set of candidate resources to create a grant. If, for example, the number of frequency resources indicated by the MAC entity is large enough to span multiple RB sets, then a SL-U multi-channel access procedure is to be performed by the UE to start a COT. Additionally or alternatively, the sidelink resources used for the RB set configuration may be selected by the UE from preconfigured sidelink resources.

In accordance with some aspects of the disclosure, the UE to may receive an uplink grant from a base station, such as to perform a NR-U uplink PUSCH transmission simultaneously with the SL-U multi-channel access transmission. The uplink grant may, for example, provide a grant of frequency resources (e.g. RB set) that are not part of a sidelink resource pool available for use by the UE for SL-U multi-channel access.

RB set configurations may comprise RBs on one or more BWPs according to aspects of the disclosure. For example, an RB set configuration of some examples may include RBs on different BWPs as a sidelink BWP and an uplink BWP in the same carrier).

In block 1802 of the illustrated example, the UE performs LBT procedures (e.g., using one or more wireless radios under control of SL-U multi-channel access logic executed by the UE) with respect to each channel bandwidth of the multiple channel bandwidths available for utilization by the SL-U multi-channel access procedure for the SL-U multi-channel access. The UE may, for example, perform LBT procedures with respect to each channel bandwidth of the channel bandwidths available for utilization by the SL-U multi-channel access procedure (e.g., independently perform procedures for each RB set of the RB set configuration, as described above with reference to FIGS. 7A and 7B).

In block 1803 of the illustrated example, the UE transmits (e.g., using one or more wireless radios of the UE under control of SL-U multi-channel access logic executed by the UE) at least a portion of one or more sidelink channels using one or more RB sets of the RB set configuration in accordance with the SL-U multi-channel access procedure and based upon results of the LBT procedures performed with respect to each channel bandwidth of the multiple channel bandwidths. For example, in operation according to a SL-U multi-channel access procedure implemented by the UE, the UE may provide all-or-nothing transmission of a single sidelink channel (e.g., a single sidelink channel to one or more SL RX UEs) based upon results of the LBT procedures for the channel bandwidths available for SL-U multi-channel access (e.g., as described above with reference to FIG. 8A). As a further example, the UE may provide partial transmission of a single sidelink channel (e.g., a single sidelink channel to one or more SL RX UEs) based upon results of the LBT procedures for the channel bandwidths available for SL-U multi-channel access (e.g., as described above with reference to FIGS. 9A and 9B). As a still further example, the UE may provide all-or-nothing transmission of multiple sidelink channels (e.g., multiple sidelink channels to one or more SL RX UEs) based upon results of the LBT procedures for the channel bandwidths available for SL-U multi-channel access (e.g., as described above with reference to FIGS. 8B and 8C). As yet a further example, the UE may provide partial transmission with respect to multiple sidelink channels (e.g., multiple sidelink channels to one or more SL RX UEs) based upon results of the LBT procedures for the channel bandwidths available for SL-U multi-channel access (e.g., as described above with reference to FIGS. 10A-10C, 11, and 12A-12C).

In some implementations, the UE be configured to perform a NR-U uplink transmission simultaneously with the SL-U multi-channel access transmission. Accordingly, in operation according to some examples of a SL-U multi-channel access procedure implemented by the UE, the UE may provide all-or-nothing transmission with respect to one or more sidelink channels (e.g., multiple sidelink channels to one or more SL RX UEs) and one or more uplink channels (e.g., one or more uplink channels to one or more base stations) based upon results of the LBT procedures (e.g., a hybrid of the examples described above with reference to FIGS. 8B and 8C). The UE may, according to further embodiments, provide partial transmission with respect to one or more sidelink channels (e.g., multiple sidelink channels to one or more SL RX UEs) and one or more uplink channels (e.g., one or more uplink channels to one or more base stations) based upon results of the LBT procedures (e.g., a hybrid of the examples described above with reference to FIGS. 10A-10C, 11, and 12A-12C).

In some implementations, the UE may create multiple redundancy versions for the sidelink channel. According to some aspects, the UE may select an appropriate version of the sidelink channel (e.g., a version of the multiple redundancy versions that may be contained within the RBs of channel bandwidths having successful LBT procedures) for transmission based upon results of LBT procedures performed with respect to each of the channel bandwidths.

FIG. 19 is a block diagram of an example UE 115 that supports SL-U multi-channel access according to one or more aspects. UE 115 may be configured to perform operations, including the blocks of a process described with reference to FIG. 18. In some implementations, UE 115 includes the structure, hardware, and components shown and described with reference to UE 115 of FIGS. 1 and 2. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 1901a-r and antennas 252a-r. Wireless radios 1901a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include SL-U RB set information 1902 and SL-U multi-channel access 1903. SL-U RB set information 1902 may comprise one or more database and/or other data structures configured to store one or more RB set configurations and/or parameters and other information for SL-U multi-channel access for use in SL-U multi-channel access according to concepts of the present disclosure. SL-U multi-channel access logic 1903 may be configured to perform various functions and operations for SL-U multi-channel access (e.g., selecting a SL-U multi-channel access procedure based upon UE capability, identifying a RB set configuration for SL-U multi-channel access, creating multiple redundancy versions for a sidelink channel, selecting an appropriate redundancy version for a sidelink channel, performing LBT procedures with respect to each channel bandwidth of multiple channel bandwidths available for utilization by a SL-U multi-channel access procedure, transmitting at least a portion of one or more sidelink channels using one or more RB sets of a RB set configuration in accordance with a SL-U multi-channel access procedure based upon results of LBT procedures performed with respect to multiple channel bandwidths, etc.) according to concepts herein. UE 115 may transmit signals to and receive signals from one or more UEs (e.g., SL RX UEs). Further, UE 115 may receive signals from and/or transmit signals to one or more network entities, such as base station 105 of FIGS. 1, 2, and 21.

FIG. 20 is a flow diagram illustrating an example process 2000 that supports SL-U multi-channel access according to one or more aspects. Operations of process 2000 may be performed by a base station (e.g., gNB or other network element), such as base station 105 described above with reference to FIGS. 1 and 2 or a base station as described above with reference to FIG. 20. For example, example operations of process 2000 may enable base station 105 to support SL-U multi-channel access based upon UE capability.

At block 2001 of process 200 illustrated in FIG. 20, the base station identifies (e.g., by operation of SL-U multi-channel access logic executed by the base station) a RB set configuration for SL-U multi-channel access. The RB set configuration may, for example, comprise a plurality of RB sets including a different RB set for each channel bandwidth of multiple channel bandwidths available for utilization by a SL-U multi-channel access procedure implemented by a UE based upon one or more capability of the UE for the SL-U multi-channel access.

In accordance with some aspects, the base station may select (e.g., under control of SLU multi-channel access logic executed by the base station) a SL-U multi-channel access procedure for use by a UE based upon one or more capability of the UE, such as in association with connection to a network by the UE, in association with establishing or maintaining a communication link between the base station and UE, in association with a sidelink resource grant, in association with scheduling sidelink communications, etc. Additionally or alternatively, a SL-U multi-channel access procedure may be selected by a UE (e.g., under control of SL-U multi-channel access logic executed by the UE) based upon one or more capability of the UE, such as in association with a sidelink resource grant, in association with scheduling sidelink communications, etc.

In some implementations, the base station may receive information regarding the one or more capability of a UE for the SL-U multi-channel access. The base station may select a particular SL-U multi-channel access procedure for implementation by a UE and/or identify a RB set configuration for use with respect to the SL-U multi-channel access procedure based at least in part on the information received from the UE.

One or more RB set configuration for SL-U multi-channel access may, according to some examples, be stored by the base station (e.g., as SL-U RB set information in a database memory of the base station) or otherwise be available to the base station. The base station may determine, select, or otherwise identify a RB set configuration for use with respect to a SL-U multi-channel access procedure implemented by a UE.

The base station may, for example, identify a RB set configuration for use in one or more sidelink grants made to a UE operating a sidelink transmission Mode 1 UE. As another example, the base station may identify a RB set configuration for use as preconfigured sidelink resources (e.g., used by a UE operating as a sidelink transmission Mode 2 UE). A RB set configuration identified for SL-U multi-channel access may comprise a FDRA spanning more than one RB set.

At block 2001 of the illustrated example, the base station transmits (e.g., using one or more wireless radios of the base station under control of SL-U multi-channel access logic executed by the base station), to the UE, one or more scheduling grant including the RB set configuration. The base station may, for example, transmit the RB set configuration to the UE via sidelink resource grant and/or scheduling signaling (e.g., a DG or CG from the base station over PDCCH (e.g., one or more DCI 3_0 information elements)). According to further examples in which the UE is operating according to a sidelink transmission Mode 2 UE, the base station may transmit one or more RB set configurations to the UE as preconfigured sidelink resources (e.g., one or more RRC information elements).

According to some aspects, in block 2002, the base station may transmit, to the UE, information regarding a SL-U multi-channel access procedure selected for implementation by the UE based upon one or more capability of the UE for the SL-U multi-channel access. For example, the base station may provide signaling (e.g., index to a database storing a plurality of SL-U multi-channel access procedures, identification of a particular SL-U multi-channel access procedure, parameters for operation of a particular SL-U multi-channel access procedure, etc.) to indicate a particular SL-U multi-channel access procedure for implementation by the UE.

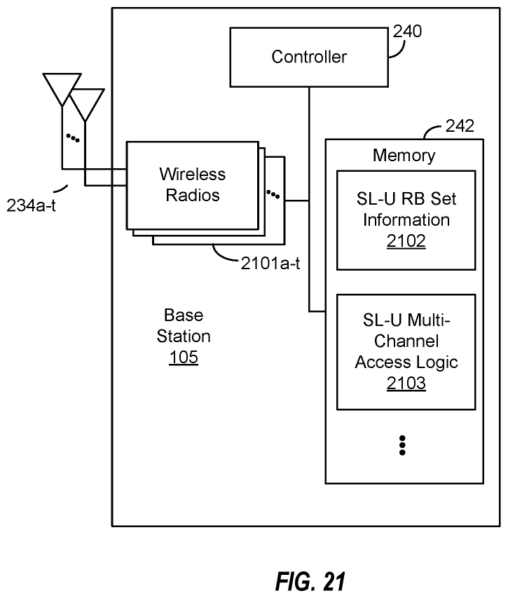

FIG. 21 is a block diagram of an example base station 105 that supports SL-U multi-channel access according to one or more aspects. Base station 105 may be configured to perform operations, including the blocks of process 2000 described with reference to FIG. 20. In some implementations, base station 105 includes the structure, hardware, and components shown and described with reference to base station 105 of FIGS. 1 and 2. For example, base station 105 may include controller 240, which operates to execute logic or computer instructions stored in memory 242, as well as controlling the components of base station 105 that provide the features and functionality of base station 105. Base station 105, under control of controller 240, transmits and receives signals via wireless radios 2101a-t and antennas 234a-t. Wireless radios 2101a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include SL-U RB set information 2102 and SL-U multi-channel access logic 2103. SL-U RB set information 2102 may comprise one or more database and/or other data structures configured to store one or more RB set configurations and/or parameters and other information for SL-U multi-channel access for use in SL-U multi-channel access according to concepts of the present disclosure. SL-U multi-channel access logic 2103 may be configured to perform various functions and operations for SL-U multi-channel access (e.g., receiving information regarding one or more capability of UE for SL-U multi-channel access, selecting a particular SL-U multi-channel access procedure based upon UE capability, identifying a RB set configuration for SL-U multi-channel access, providing grants and/or scheduling with respect to SL-U multi-channel access, etc.). Base station 105 may receive signals from and/or transmit signals to one or more UEs, such as UE 115 of FIGS. 1, 20 and 19.

It is noted that one or more blocks (or operations) described with reference to FIGS. 18 and 20 may be combined with one or more blocks (or operations) described with reference to another of the figures. For example, one or more blocks (or operations) of FIG. 18 may be combined with one or more blocks (or operations) of FIGS. 4A and 4B, 5A and 5B, 6A and 6B, and/or 7A and 7B. As another example, one or more blocks associated with FIG. 18 may be combined with one or more blocks associated with FIGS. 8A-8C, 9A, 9B, 10A-10C, 11, and/or 12A-12D. As another example, one or more blocks associated with FIG. 18 may be combined with one or more blocks (or operations) associated with FIGS. 13, 14, 15A-15D, 16A, 16B, and/or 17D. Additionally, or alternatively, one or more operations described above with reference to FIGS. 1 and 2 may be combined with one or more operations described with reference to FIG. 19 or 21.

In some examples of methods, the apparatuses, and articles including non-transitory computer-readable medium described herein, various aspects of SL-U multi-channel access may be implemented according to a multiplicity of combinations consistent with concepts described herein. Non-limiting examples of combinations of some aspects of a multi-slot transport block technique are set forth in the example clauses below.

1. Methods, apparatuses, and articles for wireless communication may provide for identifying a RB set configuration for SL-U multi-channel access, wherein the RB set configuration comprises a plurality of RB sets including a different RB set for each channel bandwidth of multiple channel bandwidths available for utilization by a SL-U multi-channel access procedure implemented by the UE based upon one or more capability of the UE for the SL-U multi-channel access, performing LBT procedures with respect to each channel bandwidth of the multiple channel bandwidths available for utilization by the SL-U multi-channel access procedure for the SL-U multi-channel access, and transmitting at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

2. The methods, apparatuses, and articles of clause 1, wherein the SL-U multi-channel access procedure is implemented by the UE based upon whether or not the UE comprises a multiple simultaneous transmission capability.

3. The methods, apparatuses, and articles of any of clauses 1 and 2, wherein the SL-U multi-channel access procedure is implemented by the UE based upon whether or not the UE comprises a predetermined capability other than a multiple simultaneous transmission capability.

4. The methods, apparatuses, and articles of clause 3, wherein the predetermined capability other than the multiple simultaneous transmission capability comprises a UE capability to simultaneously process data of multiple sidelink, or a UE capability to perform multiple simultaneous LBT procedures.

5. The methods, apparatuses, and articles of any of clauses 1-4, wherein the SL-U multi-channel access procedure provides for the transmitting at least a portion of one or more sidelink channels transmitting a single sidelink channel.

6. The methods, apparatuses, and articles of clause 5, wherein the single sidelink channel comprises PSCCH and PSSCH or a single PSBCH.

7. The methods, apparatuses, and articles of any of clauses 5 and 6, wherein the one or more capability of the UE the SL-U multi-channel access procedure is implemented by the UE based upon comprises a UE capability being a first capability or a second capability, and wherein the transmitting the single sidelink channel comprises transmitting, if the one or more capability of the UE includes the first capability, the single sidelink channel using each RB set of the RB set configuration in accordance with the SL-U multi-channel access procedure based upon results of the LBT procedures indicating each channel bandwidth of the multiple channel bandwidths being available for the SL-U multi-channel access or transmitting, if the one or more capability of the UE includes the second capability, at least a portion of the single sidelink channel using some or all of the RB sets of the RB set configuration in accordance with the SL-U multi-channel access procedure based upon results of the LBT procedures indicating respective channel bandwidths of the multiple channel bandwidths being available for the SL-U multi-channel access.

8. The methods, apparatuses, and articles of any of clauses 1-4, wherein the SL-U multi-channel access procedure provides for the transmitting at least a portion of one or more sidelink channels comprising transmitting multiple sidelink channels based upon results of the LBT procedures indicating respective channel bandwidths of the multiple channel bandwidths being available for the SL-U multi-channel access.

9 The methods, apparatuses, and articles of clause 8, wherein the multiple sidelink channels comprise multiple PSCCHs and PSSCHs, multiple PSBCH, or a combination of one or more PSCCHs and PSSCHs and one or more PSBCHs.

10. The methods, apparatuses, and articles of any of clauses 7-9, wherein the one or more capability of the UE the SL-U multi-channel access procedure is implemented by the UE based upon comprises a UE capability being a first capability or a second capability, and wherein the transmitting the multiple sidelink channels comprises transmitting, if the one or more capability of the UE includes the second capability, at least a portion of channels of the multiple sidelink channels using respective RB sets of the RB set configuration in accordance with the SL-U multi-channel access procedure based upon results of the LBT procedures indicating respective channel bandwidths of the multiple channel bandwidths being available for the SL-U multi-channel access, or transmitting, if the one or more capability of the UE includes the first capability, the multiple sidelink channels using each RB set of the RB set configuration in accordance with the SL-U multi-channel access procedure based upon results of the LBT procedures indicating each channel bandwidth of the multiple channel bandwidths being available for the SL-U multi-channel access.

11. The methods, apparatuses, and articles of any of clauses 1-10, wherein the SL-U multi-channel access procedure provides for the transmitting at least a portion of one or more sidelink channels comprising transmitting channels of the one or more sidelink channels that are fully contained in respective RB sets corresponding to channel bandwidths the LBT procedures indicate are available for the SL-U multi-channel access.

12. The methods, apparatuses, and articles of any of clauses 1-10, wherein the SL-U 12. multi-channel access procedure, for channels of the one or more sidelink channels that respectively span RB sets of more than one channel bandwidth of the channel bandwidths available for utilization by the SL-U multi-channel access procedure, provides for the transmitting at least a portion of one or more sidelink channels comprising transmitting portions of the channels of the one or more sidelink channels that are contained in respective RB sets corresponding to channel bandwidths the LBT procedures indicate are available for the SL-U multi-channel access.

13. The methods, apparatuses, and articles of clause 12, wherein the SL-U multi-channel access procedure provides for at least one portion of each of the channels of the one or more sidelink channels transmitted including sidelink control information (SCI).

14. The methods, apparatuses, and articles of clause 13, wherein the SL-U multi-channel access procedure provides for the SCI being repeated in each channel portion of each of the channels of the one or more sidelink channels transmitted.

15 The methods, apparatuses, and articles of clause 13, wherein the SL-U multi-channel access procedure provides for the SCI being included in at least one channel portion of each of the channels of the one or more sidelink channels for which one or more portions of the channels are transmitted.

16. The methods, apparatuses, and articles of clause 13, wherein the SL-U multi-channel access procedure provides for the transmitting portions of the channels of the one or more sidelink channels comprising transmitting portions of the channels of the one or more sidelink channels that respectively span RB sets of more than one channel bandwidth of the channel bandwidths when the channel bandwidths of the one or more channel bandwidths for the portions of the channels are neighboring channel bandwidths.

17. The methods, apparatuses, and articles of clause 13, wherein the SL-U multi-channel access procedure provides for the transmitting portions of the channels of the one or more sidelink channels comprising transmitting portions of the channels of the one or more sidelink channels that respectively span RB sets of more than one channel bandwidth of the channel bandwidths when the RB sets containing the portions of the channels do not include RBs in guard bands between the channel bandwidths.

18. The methods, apparatuses, and articles of clause 13, wherein the SL-U multi-channel access procedure provides for the transmitting portions of the channels of the one or more sidelink channels comprising transmitting portions of the channels of the one or more sidelink channels that respectively span RB sets of more than one channel bandwidth of the channel bandwidths when the RB sets containing the portions of the channels include RBs in guard bands between the channel bandwidths and the LBT procedures indicate each channel bandwidth of the multiple channel bandwidths adjacent to the guard bands are available for the SL-U multi-channel access.

19. The methods, apparatuses, and articles of clause 13, wherein the SL-U multi-channel access procedure provides for the transmitting portions of the channels of the one or more sidelink channels comprising transmitting portions of the channels of the one or more sidelink channels that respectively span RB sets of more than one channel bandwidth of the channel bandwidths when the RB sets containing the portions of the channels include RBs in guard bands between the channel bandwidths and a UE intended to receive the transmission has a capability to decode sidelink channels with an allocation over RBs in guard bands.

20. The methods, apparatuses, and articles of any of clauses 1-19, wherein the SL-U multi-channel access procedure provides for the transmitting at least a portion of one or more sidelink channels comprising transmitting a PUSCH and one or more sidelink channels.

21. The methods, apparatuses, and articles of any of clauses 1-20, further comprising preparing different versions of a sidelink channel of the one or more sidelink channels, wherein the SL-U multi-channel access procedure provides for the transmitting at least a portion of the one or more sidelink channels comprising transmitting a version of the different versions of the sidelink channel which is fully contained in respective RB sets corresponding to channel bandwidths the LBT procedures indicate are available for the SL-U multi-channel access.

22. The methods, apparatuses, and articles of any of clauses 1-21, further comprising transmitting, to a base station, information regarding the one or more capability of the UE for the SL-U multi-channel access.

23. The methods, apparatuses, and articles of any of clauses 1-22, further comprising selecting a SL-U multi-channel access procedure for implementation by the UE based on capabilities UE capability to simultaneously process data of multiple sidelink, UE capability to perform multiple simultaneous LBT procedures, and/or UE capability to utilize resources allocated for SL-U multi-channel access.

24. Methods, apparatuses, and articles for wireless communication may provide for identifying a RB set configuration for SL-U multi-channel access, wherein the RB set configuration comprises a plurality of RB sets including a different RB set for each channel bandwidth of multiple channel bandwidths available for utilization by a SL-U multi-channel access procedure implemented by a UE based upon one or more capability of the UE for the SL-U multi-channel access, and transmitting, to the UE, one or more scheduling grant including the RB set configuration.

25. The methods, apparatuses, and articles of clause 24, further comprising receiving, from the UE, information regarding the one or more capability of the UE for the SL-U multi-channel access, wherein the one or more scheduling grant is based at least in part on the information received from the UE.

26. The methods, apparatuses, and articles of any of clauses 24 and 25, wherein the one or more scheduling grant includes a scheduling grant with respect to one or sidelink channels and a scheduling grant with respect to an uplink from the UE to the network element.

27. The methods, apparatuses, and articles of any of clauses 24-26, further comprising selecting a SL-U multi-channel access procedure for implementation by the UE based on capabilities UE capability to simultaneously process data of multiple sidelink, UE capability to perform multiple simultaneous LBT procedures, and/or UE capability to utilize resources allocated for SL-U multi-channel access.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1, 2, 19, and 21 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
identifying a resource block (RB) set configuration for sidelink unlicensed spectrum (SL-U) multi-channel access, wherein the RB set configuration comprises a plurality of RB sets including a different RB set for each channel bandwidth of multiple channel bandwidths available for utilization by a SL-U multi-channel access procedure implemented by the UE based upon one or more capability of the UE for the SL-U multi-channel access;
performing listen-before-transmitting (LBT) procedures with respect to each channel bandwidth of the multiple channel bandwidths available for utilization by the SL-U multi-channel access procedure for the SL-U multi-channel access; and
transmitting at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

2. The method of claim 1, wherein the SL-U multi-channel access procedure is implemented by the UE based upon whether or not the UE comprises a multiple simultaneous transmission capability.

3. The method of claim 1, wherein the SL-U multi-channel access procedure is implemented by the UE based upon whether or not the UE comprises a predetermined capability other than a multiple simultaneous transmission capability.

4. The method of claim 3, wherein the predetermined capability other than the multiple simultaneous transmission capability comprises a UE capability to simultaneously process data of multiple sidelink, or a UE capability to perform multiple simultaneous LBT procedures.

5. The method of claim 1, wherein the SL-U multi-channel access procedure provides for the transmitting at least a portion of one or more sidelink channels transmitting a single sidelink channel.

6. The method of claim 5, wherein the one or more capability of the UE the SL-U multi-channel access procedure is implemented by the UE based upon comprises a UE capability being a first capability or a second capability, and wherein the transmitting the single sidelink channel comprises:
transmitting, if the one or more capability of the UE includes the first capability, the single sidelink channel using each RB set of the RB set configuration in accordance with the SL-U multi-channel access procedure based upon results of the LBT procedures indicating each channel bandwidth of the multiple channel bandwidths being available for the SL-U multi-channel access; or
transmitting, if the one or more capability of the UE includes the second capability, at least a portion of the single sidelink channel using some or all of the RB sets of the RB set configuration in accordance with the SL-U multi-channel access procedure based upon results of the LBT procedures indicating respective channel bandwidths of the multiple channel bandwidths being available for the SL-U multi-channel access.

7. The method of claim 1, wherein the SL-U multi-channel access procedure provides for the transmitting at least a portion of one or more sidelink channels comprising:
transmitting multiple sidelink channels based upon results of the LBT procedures indicating respective channel bandwidths of the multiple channel bandwidths being available for the SL-U multi-channel access.

8. The method of claim 7, wherein the one or more capability of the UE the SL-U multi-channel access procedure is implemented by the UE based upon comprises a UE capability being a first capability or a second capability, and wherein the transmitting the multiple sidelink channels comprises:
transmitting, if the one or more capability of the UE includes the second capability, at least a portion of channels of the multiple sidelink channels using respective RB sets of the RB set configuration in accordance with the SL-U multi-channel access procedure based upon results of the LBT procedures indicating respective channel bandwidths of the multiple channel bandwidths being available for the SL-U multi-channel access; or
transmitting, if the one or more capability of the UE includes the first capability, the multiple sidelink channels using each RB set of the RB set configuration in accordance with the SL-U multi-channel access procedure based upon results of the LBT procedures indicating each channel bandwidth of the multiple channel bandwidths being available for the SL-U multi-channel access.

9. The method of claim 1, wherein the SL-U multi-channel access procedure provides for the transmitting at least a portion of one or more sidelink channels comprising:
transmitting channels of the one or more sidelink channels that are fully contained in respective RB sets corresponding to channel bandwidths the LBT procedures indicate are available for the SL-U multi-channel access.

10. The method of claim 1, wherein the SL-U multi-channel access procedure, for channels of the one or more sidelink channels that respectively span RB sets of more than one channel bandwidth of the channel bandwidths available for utilization by the SL-U multi-channel access procedure, provides for the transmitting at least a portion of one or more sidelink channels comprising:
transmitting portions of the channels of the one or more sidelink channels that are contained in respective RB sets corresponding to channel bandwidths the LBT procedures indicate are available for the SL-U multi-channel access.

11. The method of claim 10, wherein the SL-U multi-channel access procedure provides for at least one portion of each of the channels of the one or more sidelink channels transmitted including sidelink control information (SCI).

12. The method of claim 1, wherein the SL-U multi-channel access procedure provides for the transmitting at least a portion of one or more sidelink channels comprising:
transmitting a physical uplink shared channel (PUSCH) and one or more sidelink channels.

13. The method of claim 1, further comprising:
preparing different versions of a sidelink channel of the one or more sidelink channels, wherein the SL-U multi-channel access procedure provides for the transmitting at least a portion of the one or more sidelink channels comprising:
transmitting a version of the different versions of the sidelink channel which is fully contained in respective RB sets corresponding to channel bandwidths the LBT procedures indicate are available for the SL-U multi-channel access.

14. A method of wireless communication performed by a network entity, the method comprising:
identifying a resource block (RB) set configuration for sidelink unlicensed spectrum (SL-U) multi-channel access, wherein the RB set configuration comprises a plurality of RB sets including a different RB set for each channel bandwidth of multiple channel bandwidths available for utilization by a SL-U multi-channel access procedure implemented by a user equipment (UE) based upon one or more capability of the UE for the SL-U multi-channel access; and
transmitting, to the UE, one or more scheduling grant including the RB set configuration.

15. The method of claim 14, further comprising:
receiving, from the UE, information regarding the one or more capability of the UE for the SL-U multi-channel access, wherein the one or more scheduling grant is based at least in part on the information received from the UE.

16. The method of claim 14, wherein the one or more scheduling grant includes a scheduling grant with respect to one or sidelink channels and a scheduling grant with respect to an uplink from the UE to the network entity.

17. A user equipment (UE) comprising:
a memory storing processor-readable code; and
at least one processor coupled to the memory, the at least one processor configured to execute the processor-readable code to cause the at least one processor to:
identify a resource block (RB) set configuration for sidelink unlicensed spectrum (SL-U) multi-channel access, wherein the RB set configuration comprises a plurality of RB sets including a different RB set for each channel bandwidth of multiple channel bandwidths available for utilization by a SL-U multi-channel access procedure implemented by the UE based upon one or more capability of the UE for the SL-U multi-channel access;
perform listen-before-transmitting (LBT) procedures with respect to each channel bandwidth of the multiple channel bandwidths available for utilization by the SL-U multi-channel access procedure for the SL-U multi-channel access; and
transmit at least a portion of one or more sidelink channels using one or more RB sets of the RB set configuration in accordance with the SL-U multi-channel access procedure and based upon results of the LBT procedures performed with respect to each channel bandwidth of the multiple channel bandwidths.

18. The UE of claim 17, wherein the SL-U multi-channel access procedure is implemented by the UE based upon whether or not the UE comprises a multiple simultaneous transmission capability.

19. The UE of claim 17, wherein the SL-U multi-channel access procedure is implemented by the UE based upon whether or not the UE comprises a UE capability to simultaneously process data of multiple sidelink or a UE capability to perform multiple simultaneous LBT procedures.

20. The UE of claim 17, wherein the SL-U multi-channel access procedure provides for transmitting a single sidelink channel.

21. The UE of claim 20, wherein the one or more capability of the UE the SL-U multi-channel access procedure is implemented by the UE based upon comprises a UE capability being a first capability or a second capability, and wherein the at least one processor is configured to execute the processor-readable code to cause the at least one processor to:
transmit, if the one or more capability of the UE includes the first capability, the single sidelink channel using each RB set of the RB set configuration in accordance with the SL-U multi-channel access procedure based upon results of the LBT procedures indicating each channel bandwidth of the multiple channel bandwidths being available for the SL-U multi-channel access; or
transmit, if the one or more capability of the UE includes the second capability, at least a portion of the single sidelink channel using some or all of the RB sets of the RB set configuration in accordance with the SL-U multi-channel access procedure based upon results of the LBT procedures indicating respective channel bandwidths of the multiple channel bandwidths being available for the SL-U multi-channel access.

22. The UE of claim 17, wherein the at least one processor is configured to execute the processor-readable code to cause the at least one processor to:
transmit multiple sidelink channels based upon results of the LBT procedures indicating respective channel bandwidths of the multiple channel bandwidths being available for the SL-U multi-channel access.

23. The UE of claim 22, wherein the one or more capability of the UE the SL-U multi-channel access procedure is implemented by the UE based upon comprises a UE capability being a first capability or a second capability, and wherein the at least one processor is configured to execute the processor-readable code to cause the at least one processor to:
transmit, if the one or more capability of the UE includes the second capability, at least a portion of channels of the multiple sidelink channels using respective RB sets of the RB set configuration in accordance with the SL-U multi-channel access procedure based upon results of the LBT procedures indicating respective channel bandwidths of the multiple channel bandwidths being available for the SL-U multi-channel access; or
transmit, if the one or more capability of the UE includes the first capability, the multiple sidelink channels using each RB set of the RB set configuration in accordance with the SL-U multi-channel access procedure based upon results of the LBT procedures indicating each channel bandwidth of the multiple channel bandwidths being available for the SL-U multi-channel access.

24. The UE of claim 17, wherein the at least one processor is configured to execute the processor-readable code to cause the at least one processor to:
transmit channels of the one or more sidelink channels that are fully contained in respective RB sets corresponding to channel bandwidths the LBT procedures indicate are available for the SL-U multi-channel access.

25. The UE of claim 17, wherein the at least one processor is configured to execute the processor-readable code to cause the at least one processor to:
for channels of the one or more sidelink channels that respectively span RB sets of more than one channel bandwidth of the channel bandwidths available for utilization by the SL-U multi-channel access procedure, transmit portions of the channels of the one or more sidelink channels that are contained in respective RB sets corresponding to channel bandwidths the LBT procedures indicate are available for the SL-U multi-channel access.

26. The UE of claim 25, wherein the SL-U multi-channel access procedure provides for at least one portion of each of the channels of the one or more sidelink channels transmitted including sidelink control information (SCI).

27. The UE of claim 17, wherein the at least one processor is configured to execute the processor-readable code to cause the at least one processor to:
transmit a physical uplink shared channel (PUSCH) and one or more sidelink channels.

28. The UE of claim 17, wherein the at least one processor is configured to execute the processor-readable code to cause the at least one processor to:
prepare different versions of a sidelink channel of the one or more sidelink channels; and
transmit a version of the different versions of the sidelink channel which is fully contained in respective RB sets corresponding to channel bandwidths the LBT procedures indicate are available for the SL-U multi-channel access.

29. A network entity comprising:
a memory storing processor-readable code; and
at least one processor coupled to the memory, the at least one processor configured to execute the processor-readable code to cause the at least one processor to:
identify a resource block (RB) set configuration for sidelink unlicensed spectrum (SL-U) multi-channel access, wherein the RB set configuration comprises a plurality of RB sets including a different RB set for each channel bandwidth of multiple channel bandwidths available for utilization by a SL-U multi-channel access procedure implemented by a user equipment (UE) based upon one or more capability of the UE for the SL-U multi-channel access; and
transmit, to the UE, one or more scheduling grant including the RB set configuration.

30. The network entity of claim 29, wherein the one or more scheduling grant includes a scheduling grant with respect to one or sidelink channels and a scheduling grant with respect to an uplink from the UE to the network entity.
